(19) United States
(12) Patent Application Publication
(10) Pub. No.: US 2026/0287513 A1
(43) Pub. Date: Sep. 24, 2026

(54) SYSTEMS AND METHODS FOR ANALYZING AND SORTING TREATED SEEDS

(71) Applicant: CRC R&D, LLC, Kenner, LA (US)

(72) Inventors: Ronald H. Mains, JR., Kenner, LA (US); Tom Lombard, Kenner, LA (US)

(21) Appl. No.: 19/549,201

(22) Filed: Feb. 25, 2026

Related U.S. Application Data
(60) Provisional application No. 63/764,403, filed on Feb. 27, 2025.

(51) Int. Cl. G01N 21/85; B07C 5/342; G06T 7/00; G06T 7/60; G06T 7/90

(52) U.S. Cl. CPC G01N 21/85; B07C 5/3425; G06T 7/0012; G06T 7/60; G06T 7/90; G01N 2021/8592; G06T 2207/20081; G06T 2207/20084

(57) ABSTRACT

A process for using image information to identify germination viable and germination non-viable seeds. A classifier algorithm must is initially trained to identify non-viable seeds and viable seeds. Once the classifier algorithm is trained, the classifier algorithm may be implemented to sort viable and non-viable seeds in a semi-autonomous or fully autonomous system.

### CROSS REFERENCE

The present application claims the benefit of the filing date of U.S. Provisional Patent Application No. 63/764,403 having a filing date of Feb. 27, 2025, the entire contents of which are incorporated herein by reference.

### FIELD

The present disclosure relates to analysis and sorting of seeds that have been treated with a pigment or colorant.

### BRIEF DESCRIPTION OF THE DRAWINGS

FIG. 1 illustrates a process for training a seed classifier, in an embodiment.

FIG. 2 illustrates a germination tray, in an embodiment.

FIG. 3 illustrates scanning seeds on a scanner, in an embodiment.

FIG. 4 illustrates scanning seeds on a scanner, in an embodiment.

FIG. 5 illustrates seeds germinated in the germination tray, in an embodiment.

FIG. 6 illustrates a mathematical model for training a classifier, in an embodiment.

FIG. 7 illustrates a schematic system for sorting seeds, in an embodiment.

FIG. 8 illustrates a process for sorting seeds, in an embodiment.

### DETAILED DESCRIPTION

Referring now to the figures, in which like numerals indicate the same or similar elements in the various views, systems and methods for analyzing treated seeds are discussed.

In the agricultural industry, farmers purchase seeds from seed producers or their distributors. Commonly, purchased seed have an identified germination rate. For instance, a germination rate of 95% indicates that 95 out of 100 of the seeds purchased will germinate when planted assuming near standard growing conditions. In practice, farmers tend to over purchase the seed and return unused seed to the seed producer and/or distributor. Upon return, the seeds may undergo another germination test and if passing with a high enough rate the seeds may be repackaged and resold. Alternatively, if the seeds fall below a predetermined germination threshold, they may be blended with higher germination rate seeds to achieve a desired germination rate or resold as an economy blend that is known by the seller and purchaser to have a lower germination rate.

In practice, seeds having a germination rate of less than about 87% are typically discarded. Such seeds include returned seeds and seeds that have been stored for more than one growing season. In the latter regard, germination rates of seeds tend to fall with each year of storage. Further complicating seed disposal are treatments applied to the seeds. As will be appreciated, most commercial seeds (e.g., corn, soybeans, oats, canola etc.) are treated with, for example, insecticides, fungicides to name a few. These treatments are typically color coated such that a seed colorant is added to the seed. Different coating may often be identified by different colors. Disposal of such treated seeds typically requires depositing such seeds in a superfund site or incinerating the seeds. By some estimates, one of the major U.S. corn seed producers discards approximately 1900 truckloads of corn seed annually. With an average of 600 seed bags per truck this results in 1.14 million discarded seed bags. With each discarded seed bag having a retail value of approximately 350 dollars, this results in nearly 400 million dollars in discarded seed (e.g., lost sales) prior to the costs associated with transporting and discarding the treated seeds in an approved manner (e.g., disposal costs).

Accordingly, it would be desirable to sort seeds based on germination viability. That is, it would be desirable to sort bulk seed having an overall germination rate below a lower accepted minimum threshold to allow for removal of non-viable seeds from viable seeds. This is, if enough non-viable seeds are removed, the remaining seeds may exceed a minimum threshold for sale resulting in fewer seeds being discarded thereby reducing lost sales and disposal costs.

The present disclosure is broadly directed to using image information to identify viable and non-viable seeds and, in an embodiment, identify germination viability of treated seeds having a colored coating(s). Initially, a classifier algorithm must be trained to identify non-viable seeds from viable seeds. Once the classifier algorithm is trained, the classifier algorithm may be implemented to sort viable and non-viable seeds in a semi-autonomous or fully autonomous system. In various embodiments, two or more classifiers by be trained for seeds having different colored coatings. Once these multiple color-specific classifiers are trained, the color specific classifier algorithms may be used in a semi-autonomous or fully autonomous system to both sort seeds by color and sort seeds by germination viability.

In an embodiment, an AI or machine-learning based method for modeling a mapping between input parameters (e.g., seed images) and at least one output parameter (viable or nonviable seeds) includes two phases: a training/learning phase and a usage phase. In an embodiment, the learning phase uses sets of training data (e.g., information associated with imaged individual seeds) with ground truth values (e.g., actual germination information for the imaged the seeds).

Such a database may be generated from data collected from hundreds or thousands (or more) individual seeds. In this database, each training set may be represented by a number of features identified from images of individual seeds. These features may include, without limitation, size, shape, color, areas of discoloration, surface texture etc. Additional seed information may also be input for each individual seed. Such information includes seed breed (corn, soybean etc.), age, treatment applied to the seeds, color of seed treatment etc. This information from image analysis of the individual seeds may be acquired in an automated process (e.g., via image analysis) and/or may include annotations identified by technicians. Once the seeds are imaged and information for the individual seeds is acquired and stored to a database (e.g., input information), the individual seeds undergo a germination process. For each individual seed, the results of the germination process are recorded and stored to the database. Such information from the germination process may include a binary determination (e.g. non-germinated vs. germinated) or may use a range of germination values (e.g., non-germination, inadequate germination, adequate germination, full germination). The germination information may be determined in an automated process (e.g., automated image analysis) and/or be fully or partially identified by technicians. The classifier training phase then learns or trains a mapping between the features of the input information (seed information) and the output information or ground truth values (e.g., germination information) by minimizing the best fit between the features of the input information and ground truth values over the entire training database. Of note, such a database may include thousands of training sets. Once training is completed, a mathematical model (i.e., classifier) is trained that predicts the viability of seeds based on the input of seed images. As will be appreciated, the seed features identified by a trained classifier(s) that determine viability or non-viability of subsequent seeds may not be readily apparent based on a simple visual inspection of the seeds. The neural network of the classifier makes such determinations based on training experiences,

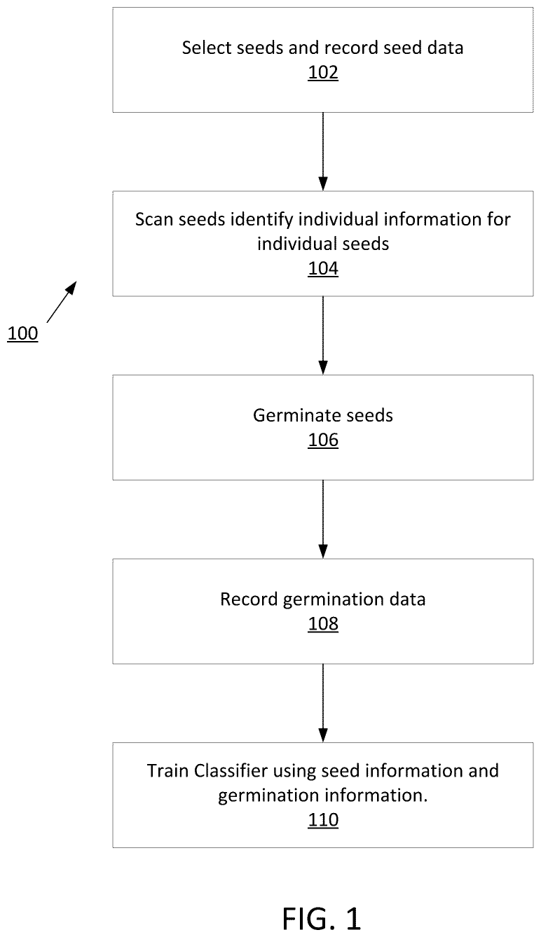

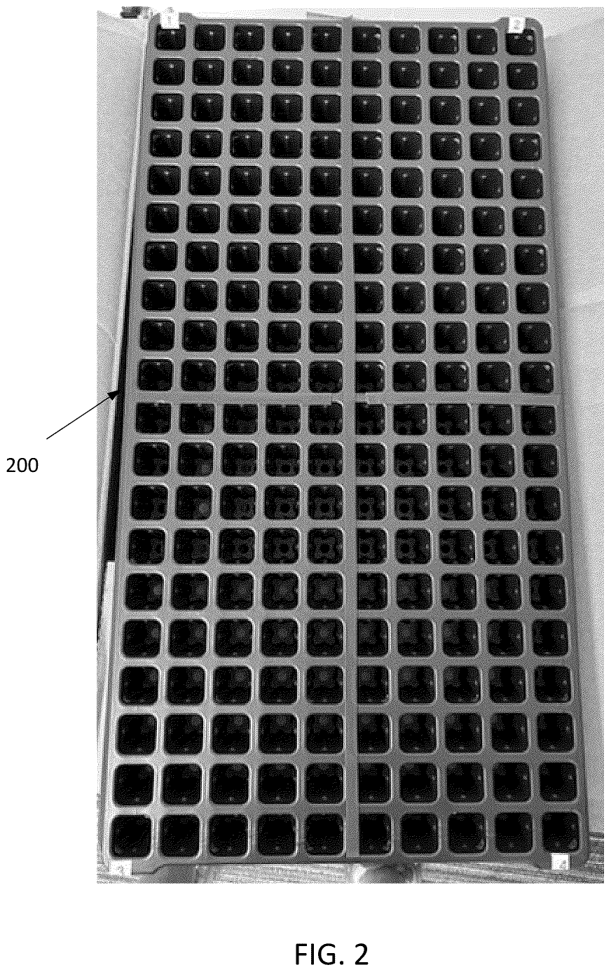

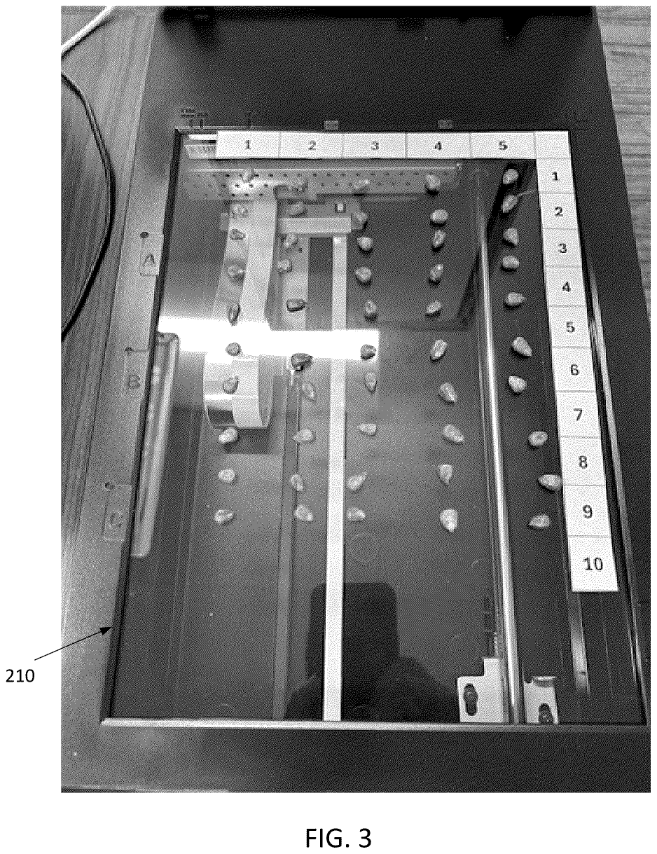

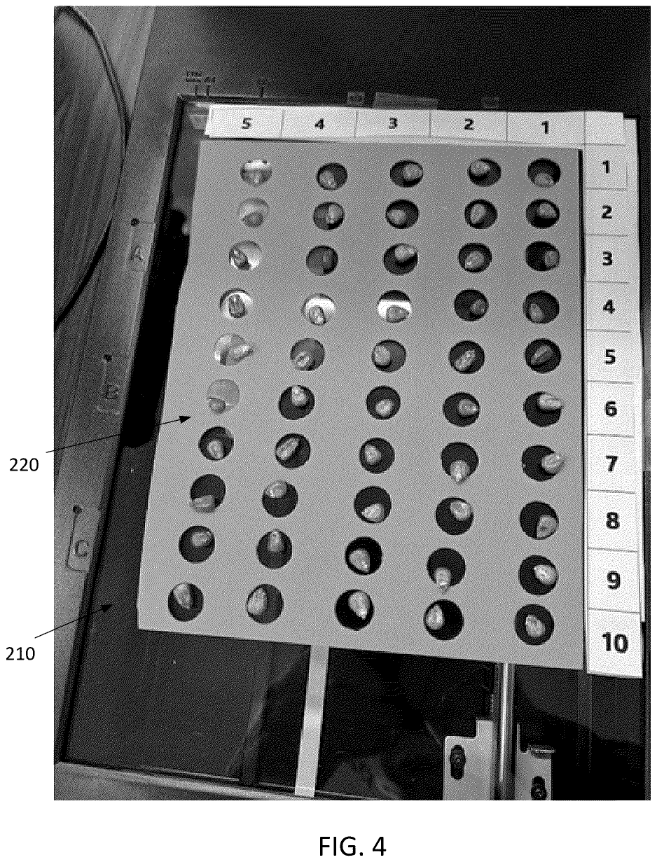

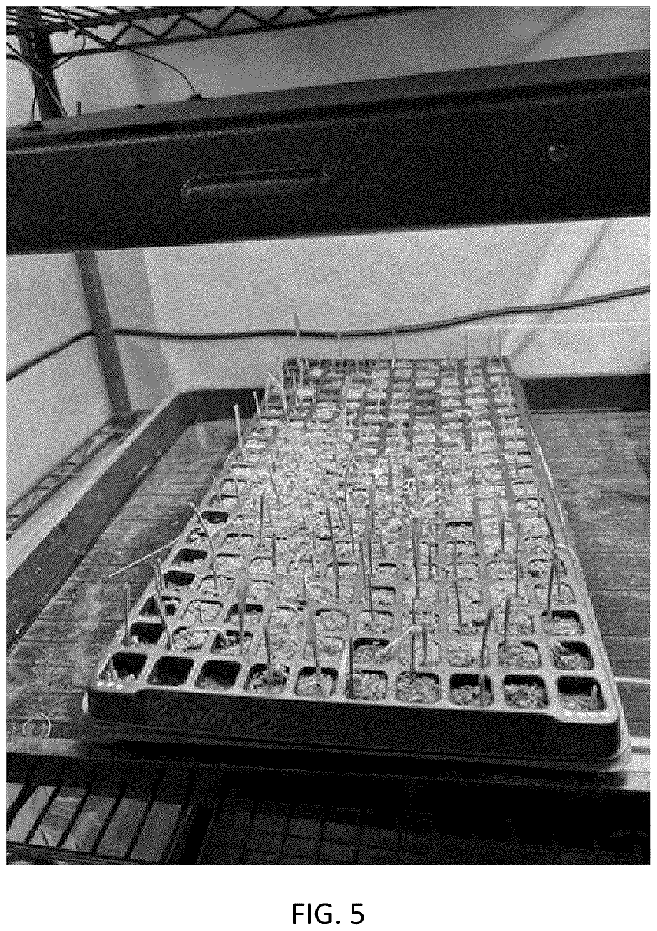

As set forth herein, the training of a classifier algorithm is set forth in relation to classifying the germination viability of treated corn seeds. However, it will be appreciated that the systems and processes discussed herein may be applied with other types of seeds. FIG. 1 illustrates a process 100 for preparing seeds for initial seed information collection and germination information collection for uses in training a classifier to determine the viability of seeds. Prior to the start of the process a germination tray 200 may be prepared. See FIG. 2. In an embodiment, a 200 square plug tray 200 may be used having 200 individual planting squares (e.g., 1.5 inch per square). In the illustrated embodiment, the tray 200 is divided into four quarters each having 50 planting squares. Each quarter may be labeled (e.g., numerically 1-4) and each square may be labeled with an individual number. Once the tray is prepared, seeds for classification may be selected and seed data for the seeds may be recorded 102. Such information may include, without limitation, inputting details into a computer database such as seed type (e.g., hybrid etc.), size, batch code etc. Once the seed information is recorded, the seeds may be scanned 104 to identify individual information for individual seeds. This is illustrated in FIGS. 3 and 4. As shown, the seeds may be arranged on a scanner 210 in an order they will be planted into the seed tray 200. Further, a mask 220 may be used to isolate each seed. See FIG. 4. As shown in FIGS. 3 and 4, the seeds are arranged in five lines of seeds with each line being 10 deep to correspond to the quadrant of the tray 200 in which each seed will be planted. The seeds are scanned and information for each individual seed may be saved to the database, for instance, indexed against a unique identifier associated with their scanning position and eventual position in the germination tray 200. As noted above, image analysis may be used to acquire individual information for each seed. Further, a technician may optionally analyze and/or enter further information for individual seeds. Once scanned, the seed are planted in the germination tray 200 and allowed to germinate as illustrated in FIG. 5. Germination information for each individual seed is collected and stored to the database (e.g., as indexed to each individual seed/location). Such germination information may be binary (germinated, did not germinate) or include a range of germination information (binary, early germination, late germination, robust growth, lethargic growth, etc.). The seed information along with the germination information is then provided to train a classifier.

The type of machine learning algorithm used to train the classifier may be, among others, a supervised, semi-supervised, and/or reinforcement-based learning algorithm. For example, machine learning algorithms, such as regression algorithms (linear, non-linear, or logistic), decision trees or graphs, association rule learning, artificial neural networks, support vector machines, inductive logic programming, Bayesian networks, instance-based learning, manifold learning, sub-space learning, deep learning, dictionary learning, etc., may be used. The following discussion utilizes a nonlimiting embodiment of a deep learning neural network. However, it will be appreciated that the present disclosure is not limited to a deep learning neural network and that other machine learning algorithms may be implanted with the described systems and methods.

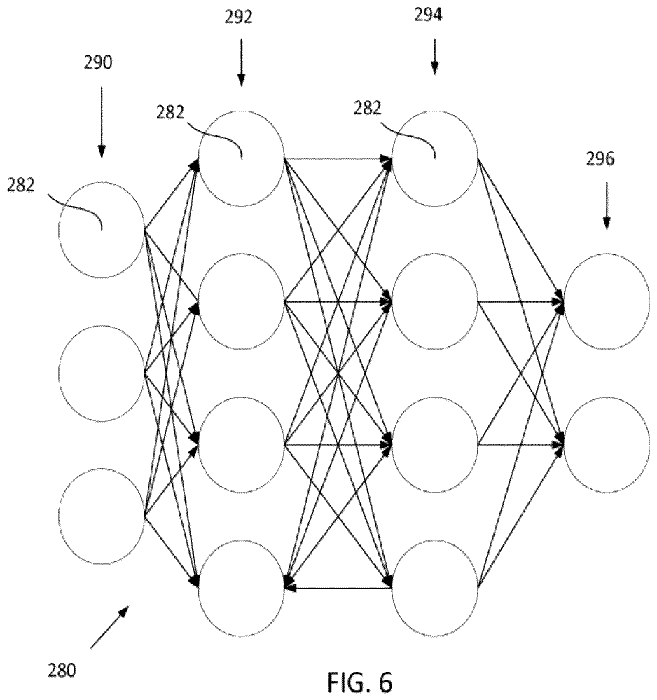

FIG. 6 illustrates a non-limiting embodiment of a feed forward deep neural network 280. In this embodiment, the neural network 280 forms a mathematical model (e.g., classifier). The neural network 280 comprises of a large number of computing units called neurons or nodes 282 each having multiple inputs and a single output (which may be output to multiple forward nodes). The nodes are typically connected in layers ‘l’ (e.g., layers 290-296) with the output of nodes in one layer being connected to all nodes in a forward layer. Deep learning represents a neural network with at least two hidden layers (e.g., layers 292, 294 between the input layer 290 and the output layer 296). Deep learning describes learning that includes learning hierarchical features from raw input data input into the input layer 290 to make predictions at the output layer 296. Deep learning models include deep neural networks (DNN), convolutional deep neural networks, deep belief networks, etc. In any arrangement, DNNs have multiple layers that enable hierarchical feature learning, as described above.

Broadly, the neural network 280 is designed to recognize features or patterns by mapping inputs to outputs by finding correlations between the inputs and outputs. Each node combines input data with a set of coefficients, or weights (e.g., connections between the nodes), that either amplify or dampen that input assigning significance to the input(s) for the task the algorithm is learning. The input-weight products are summed and passed through an activation function to generate an output that forms the next layer's input. Generally, each cycle of the neural network involves an estimation (e.g., output), an error measurement and an update in the weights and/or coefficients. In an embodiment, the error may be calculated based on a difference between an estimation and ground truth values. The neural network measures the error and attempts to adjust the weights to the extent that they contributed to the error. The process repeats in an effort to minimize the error.

In an embodiment, an output of a node i in a layer, called the activation, is computed as a function of its inputs as follows:

$${a}_{i} ( l ) = F ( ( {\sum }_{j - 1 … k} {w}_{ij} ( l - 1 , l ) * {a}_{j} ( l - 1 ) ) + {b}_{i} )$$

where wᵢⱼ is the weight associated with the connection between nodes i and j and bᵢ is a bias term associated with node i. The weights and bias terms constitute the parameters of the network to be learned to accomplish the specified task. The activation function, F, associated with individual nodes in the network is a pre-defined non-linear function. In some embodiments, the activation function includes a sigmoid or hyperbolic tangent.

In an embodiment, the neural network 280 may be trained by back-propagation using gradient descent (e.g., to minimize error). Stochastic gradient descent is a variant that may be used where training inputs are processed in a random order. The inputs may be processed one at a time with the following steps performed for each input to update the model weights.

Activation describes the output of each node i in a given layer. The activation a may be computed by a process called feed-forward evaluation, in an embodiment. The activation a may be computed as a function of k inputs from nodes j in a preceding layer (e.g., l−1), though the first layer utilizes input data. If wᵢⱼ(l−1,l) is the weight associated with a connection between node j in layer l−1 and node i in layer l, then the feed-forward evaluation is as follows:

$${a}_{i} ( l ) = F ( ( {\sum }_{j - 1 … k} {w}_{ij} ( l - 1 , l ) * {a}_{j} ( l - 1 ) ) + {b}_{i} ) ,$$

where b is a bias term for the node i. Error terms, δ, are computed for each node i in the output layer lₙ, first as follows:

$${δ}_{i} ( {l}_{n} ) = ( {t}_{1} ( {l}_{n} ) - {a}_{i} ( {l}_{n} ) ) * {F}^{′} ( {a}_{i} ( {l}_{n} ) ) ,$$

where t(x) is the true value of the output and F′(x) is the derivative of F(x). These error terms may then be back-propagated for each node i in layer l connected to nodes m in layer l+1 as follows:

$${δ}_{i} ( l ) = ( {\sum }_{j - 1 … m} {δ}_{j} ( l + 1 ) * {w}_{ji} ( l , l + 1 ) ) \cdot * {F}^{′} ( {a}_{i} ( l ) ) .$$

The error terms are used to update the weights (and biases similarly) as follows:

$$Δ {w}_{ij} ( l - 1 , l ) = α * {δ}_{i} ( l ) * {a}_{j} ( l - 1 ) for j = 1 … k ,$$

where α is a learning rate parameter.

This process may be repeated for each input until an entire training dataset has been processed, which constitutes a training cycle or epoch. At the end of a training cycle, the model prediction error may be computed on a validation set. Typically, training continues for multiple cycles, reprocessing the training data set each time, until the validation set error converges to a desired value below a predetermined threshold. The trained model may then be evaluated on test data. Upon completing the training on the training data sets (e.g., hundreds or thousands), automated classification of seed viability may be identified by inputting a raw images into the trained mathematical model/classified. The above represents a single exemplary neural network that may represent one embodiment of a classifier. Other models are possible and within the scope of the present disclosure.

In a usage phase, the classifier is utilized in a process to rapidly scan seeds. Seeds classified as viable are kept and seeds classified and nonviable are removed/discarded. As a result, viable seeds that were previously discarded for being in a bad lot having an overall germination rate below an acceptable threshold are retained. As such, the amount of waste product may be significantly reduced.

While a single classifier may be trained for separating viable color coated seeds from non-viable color coated seeds, in some instances it may be desirable to train two or more classifiers for use with different colored seeds that are mixed together. As shown in FIG. 4, it is common practice for a bag of commercial seeds to include a mixture of seeds with different colored coatings 240 and 242. For instance, it is common to sell bulk seeds including a mixture of GMO seeds (e.g., hybrid seeds) and non-GMO seeds. Many GMO or hybrid seeds are bred to be non-susceptible to various insects or diseases. Typically, non-susceptible seeds (e.g., GMO/hybrid seeds) are mixed with a percentage of susceptible seeds (e.g., non-GMO/hybrid seeds) to prevent breeding resistant insects or diseases. That is, if 100% of planted seeds were non-susceptible, insects or diseases may adapt to these non-susceptible seeds. Mixing in a percentage of susceptible seeds reduces the likelihood of the insects or diseases becoming resistant to the non-susceptible seeds. By way of example, corn seeds are sometimes mixed in a range of around 80% non-susceptible seeds and around 20% if susceptible seeds. The GMO/hybrid seeds 240 and the non-GMO seeds 242 have different color coatings. As there coatings may have differing optical properties, it may be desirable to train separate classifiers for each color coating. In this regard, a system applying the classifier may apply different classifiers for different colored seeds.

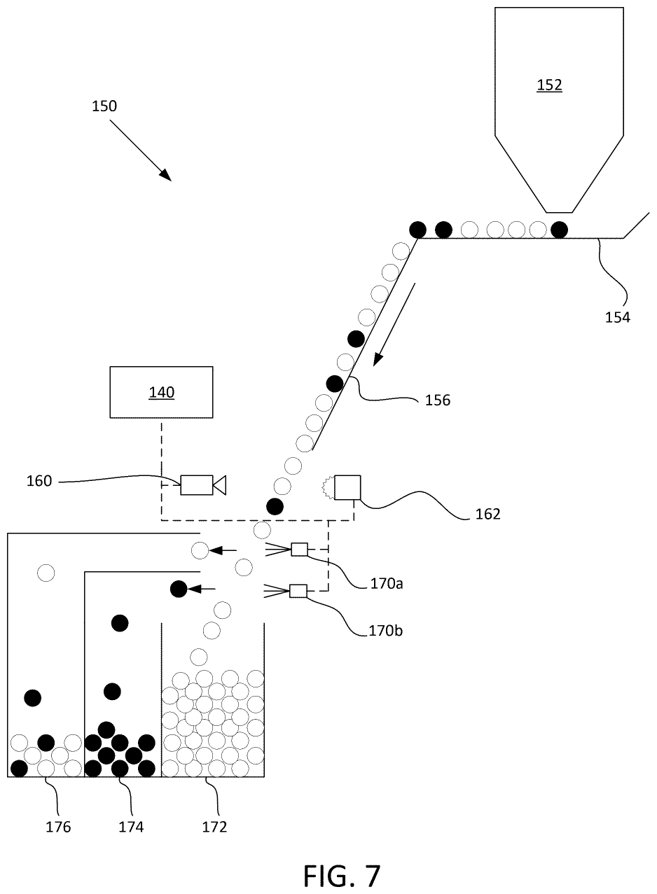

FIG. 7 shows a schematic representation of an exemplary optical sorter system 150 that may be used to both sort seeds by color and/or sort seeds by germination viability. In some embodiments, the optical sorter system 150 may be a modified commercially available seed sorter. In the depicted embodiment, the optical seed sorting system 150 includes at least one seed hopper 152 for receiving a plurality of seeds for color sorting and/or germination viability sorting. The optical sorting system 150 also includes at least one optical sensor (e.g., camera or vision system) 160 and one or more ejector devices 170a, 170b.

In an embodiment, the seed hopper 152 allows seeds to fall on to a horizontal vibratory shaker 154 that is tilted downward toward a slanted chute or channel. Seeds supplied from the vibratory shaker to the slanted chute 156 flow downward aided by gravity. The seeds flow downward on the channel or through the chute and mab be capable of spreading laterally (not shown). As will be appreciated, the seeds may flow through a plurality of parallel chutes or channels enabling sorting at a high-speed and high throughput.

Seeds on the chute 156 fall by gravity, in the illustrated embodiment, which helps to increase the distance between the individual particles. Then, in an inspection area, optical sensors and/or cameras 160 image each individual seed. That is, high-resolution cameras 160 capture images or data reflecting the color, shape, and size of each seed. In addition, as the seeds move through the system, they may be illuminated (e.g. backlit) by a light source 162. This could be visible light, infrared, ultraviolet, or a combination, depending on the types of materials being sorted. The light helps to highlight the different optical properties of the seeds. The type of light may be related to the color of the seeds and/or the type of light used to image seeds for classifier training.

The captured images are sent to an image analyzer 140 equipped with image processing software. This software analyzes the images to determine the color of each seed. In addition, the analyzer 140 applies one or more classifiers to the images to classify the seed as germination viable or non-viable. As illustrated, each seed is imaged to determine color and germination viability. If the seed is identified as germination non-viable by the trained classifier, which may be a color coating specific classifier, the computer sends a signal to an ejector 170a (e.g. air jets) which moves the seed from the main flow path into a reject bin 176. For seeds identified as viable, a second ejector 170b may separate the seeds based on color. For instance, the ejector 170b may be activated to move black seeds (as illustrated) to a viable black seed bin 174. Viable white seeds may move into a viable white seed bin 172 (e.g., without activating any ejector). Though discussed as using separate ejectors for three-way sorting, it will be appreciated that a single ejector may be utilized for multiple way sorting.

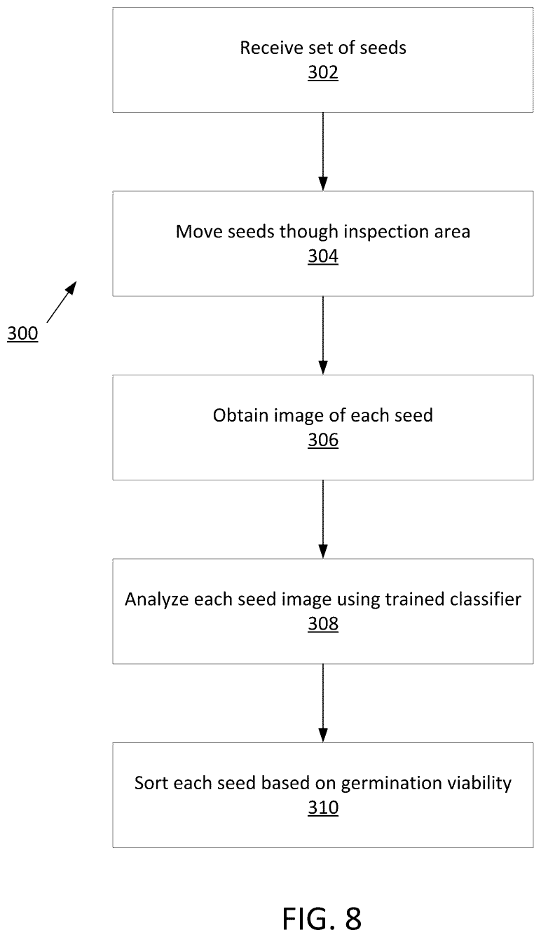

FIG. 8. illustrates a process 300 for sorting seeds based on germination viability in a seed sorting system such as discussed in relation to FIG. 7. Initially, a set of seeds is received 302. The set of seeds may includes seeds of a single color or a set of seeds having two or more colors. The seeds are moved 304 through an inspection area. An image of each seed is obtained 306 and analyzed. The analysis 308 of each seed is performed using a trained classified to determine the germination viability of the seed. The trained classified may be trained for a specific color coating of the seed. If so, the color of the seed may initially be determined and a classifier trained for that color coating may be selected to analyze the seed image. Once classified as germination viable or non-viable, the seeds are sorted 310 based on their germination viability.

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A computer implemented system for classifying a seed, comprising:
a database for storing seed information and germination information for a plurality of seeds, wherein the seed information and germination information for the plurality of seeds collectively define a plurality of seed training sets;
an imager for imaging individual seeds and recording individual seed information to the database;
a germination input for acquiring germination information for the individual seeds after planting and storing the individual germination information to the database;
a neural networ that receives the plurality of seed training sets as input and output values to generate a trained seed classifier that is configured to determine from an image of a seed if the seed is one of:
germination viable; and
germination non-viable.

2. The system of claim 1, where the imager further comprises an image analyzer that acquires one or more measurements from individual seed images.

3. The system of claim 1, where the measurements are at least one of width, height, area, color, hue, intensity, and texture.

4. The system of claim 1, wherein the imager is a color digital scanner.

5. The system of claim 1, wherein the germination input is an imager configured to input the germination information based on image analysis.

6. The system of claim 1, further comprising:
a sorter system having an imager to image seeds, wherein the imager provides seed images to the trained seed classifier, wherein the sorter sorts the seeds based on an output of the trained seed classifier.

7. The system of claim 1, wherein the neural network is a deep neural network.

8. A method for training a seed classifier, comprising:
imaging a plurality of individual seeds;
acquiring image derived seed information for each individual seed and storing the image derived seed information into a neural network training database;
acquiring germination information for each individual seed after the individual seeds are imaged and planted, and storing individual seed germination information to the neural network training database;
using the image derived seed information and the seed germination information for a plurality of individual seeds as input and output values of a neural network to generate a classifier for classifying seeds as at least one of germination viable and germination non-viable.

9. The method of claim 8, wherein acquiring image derived seed information comprises acquiring one or more of the width, height, area, color, hue, intensity, and texture from individual seed images.

10. The method of claim 8, wherein acquiring germination information comprises acquiring the germination information from one or more images.

11. The method of claim 8, wherein the germination information is acquired after the individual seeds are planted for a predetermined time.

12. A seed sorting system configured to sort viable seeds from non-viable seeds, comprising:
a seed hopper for holing a plurality of individual seeds;
a conveyor for moving individual seeds from the seed hopper to an inspection area;
an imager for imaging individual seeds as they move through the inspection area and generating an image output for each individual seed;
an image analyzer configured to receive the image output for each individual seed and apply a trained germination classifier to the image and generate a germination output classifying the seed as germination viable and germination non-viable;
an ejector device in communication with the image analyzer, wherein the ejector device is operative to remove an individual seed at is moves through the inspection area upon receiving a germination non-viable classification output from the image analyzer.

13. The system of claim 12, wherein the seed hopper receives seeds having a first coating having a first color and a second coating having a second color.

14. The system of claim 13, wherein the image analyzer if further configured to:
identify the individual seed as having the first color or the second color.

15. The system of claim 14, wherein the image analyzer applies a color specific trained germination classifier the image based on the individual seed being identified as the first color or the second color.

16. The system of claim 14, wherein the image analyzer is further configured to generate a color output for the seed.

17. The system of claim 16, wherein the ejector device is operative sort the seed based on both the color output and the germination output.
